(19) United States
(12) Patent Application Publication
(10) Pub. No.: US 2013/0184124 A1
(43) Pub. Date: Jul. 18, 2013

(54) PORTABLE MODULAR HANGING AND PULLING SYSTEM

(71) Applicant: John Huttson Reed, Jackson, WY (US)

(72) Inventor: John Huttson Reed, Jackson, WY (US)

(21) Appl. No.: 13/352,450

(22) Filed: Jan. 18, 2012

(51) Int. Cl. A63B 21/00; B23P 17/04

(52) U.S. Cl. 482/37; 29/428

(57) ABSTRACT

One embodiment of the present invention relates to a portable modular hanging and pulling system comprising a first and second bearing member, two coupling members, and a modular surface. The coupling members may be elongated U-shaped rigid support type structures. The first and second bearing members may be coupled at independent lengthwise locations along the coupling members corresponding to the left and bottom regions of the U-shape. The modular surface may be coupled to the coupling members at a lengthwise location corresponding to the right region of the U-shape. The modular surface may include a grid of at least four coupling recesses configured to releasable couple gripping regions including various shaped holds, hangboards, features, accessories, etc.

### FIELD OF THE INVENTION

The invention generally relates to hanging and pulling systems. In particular, the present invention relates to hanging and pulling systems that are both portable and modular.

### BACKGROUND OF THE INVENTION

The broad category of exercise equipment includes subcategories of systems that facilitate specific user exercises or movements. One particular type of exercise or movement is a hanging and/or pulling type of exercise such as a pull-up, chin-up, or dead hang. Various systems, such as a pull-up bar or a hangboard, are designed to enable users to perform these hanging and pulling type of exercises. Unfortunately, most pull-up bars and hangboards require advanced and/or substantially permanent installation.

Another subcategory of exercise equipment relates to portable equipment which may be transported and used in a variety of locations. Portable exercise equipment that is also designed for hanging and pulling type of exercises include door pull-up bars configured to attach to a door opening. Conventional portable pull-up bars include systems designed to wedge within the door frame and/or lever between the front and rear of the door opening. In general, the lever type of pull-up bar is more secure because the downward gravitational hanging force of the user is translated to a lever compression force upon the frame and door opening.

Unfortunately, conventional portable pull-up bars only facilitate limited exercises. It is well known that the shape, orientation, and angle of the gripping surface upon which the user performs pulling and hanging exercises effect the muscles engaged during a particular exercise. For example, a traditional pull-up (hands oriented distally) engages a larger percentage of a user's back muscles in comparison to a chin-up (hands oriented proximally). Likewise, the specific shape of the gripping surface has a substantial effect on the recruitment of certain specific hand and forearm muscles. For this reason, athletes generally prefer to train on a variety of gripping surfaces to increase muscle compensation. In addition, rock climbers prefer to train a wide variety of gripping surfaces that correspond to natural rock including crimps, slopes, and pinches.

Conventional portable pull-up and hanging systems are limited in the number of gripping surfaces or gripping positions. In particular, most portable pull-up bars include only one or two gripping positions. The gripping region of a portable pull-up bar is generally a circular region oriented either parallel or perpendicular to the corresponding door opening. Subsequently, the portable pull-up bars do not include a sufficient variety in gripping orientations, shape, size, etc. desired by most users. Likewise, conventional multi-grip systems such as a hangboard, systemboard, or artificial climbing wall generally require advanced and/or permanent installation.

Therefore, there is a need in the industry for a modular hanging and pulling system that enables users to perform a variety of pulling and hanging exercises that is also portable.

### SUMMARY OF THE INVENTION

The present invention relates to portable hanging and pulling systems. One embodiment of the present invention relates to a portable modular hanging and pulling system comprising a first and second bearing member, two coupling members, and a modular surface. The coupling members may be elongated U-shaped rigid support type structures. The first and second bearing members may be coupled at independent lengthwise locations along the coupling members corresponding to the left and bottom regions of the U-shape. The modular surface may be coupled to the coupling members at a lengthwise location corresponding to the right region of the U-shape. The modular surface may include a grid of at least four coupling recesses configured to releasable couple gripping regions, including various shaped holds, hangboards, features, accessories, etc. A second embodiment of the present invention relates to a method for attaching a modular surface to a door opening, including supporting the modular surface in an exterior region spaced from the door opening.

Embodiments of the present invention represent a significant advance in the field of portable modular hanging and pulling equipment. Prior art portable hanging and pulling equipment fails to provide significant diversity in gripping surfaces and positions. Therefore, users are forced to limit their gripping exercises, preventing adequate training of certain muscles groups including the hand and forearm muscles. Prior art hanging and pulling equipment often requires advanced and/or permanent installation. Therefore, these types of hanging and pulling devices cannot be utilized by users in locations that do not allow for permanent installation. Embodiments of the present invention overcome both of these problems with prior art devices within one portable, modular system.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a frontal perspective view of a portable modular hanging and pulling system in accordance with embodiments of the present invention;

FIG. 2 illustrates a frontal perspective view of an alternative modular hanging and pulling system in accordance with embodiments of the present invention;

FIG. 3 illustrates a rear perspective view of the system illustrated in FIG. 2;

FIG. 4 illustrates a rear perspective view of the system illustrated in FIG. 1;

FIG. 5 illustrates the operation of the system illustrated in FIG. 2 with respect to a door opening and a user;

FIG. 6 illustrates a detailed view of the engagement between the system and a door opening to facilitate portability; and

FIG. 7 illustrates a detailed rear view of the modular surface.

### DETAILED DESCRIPTION OF THE INVENTION

The present invention relates to portable hanging and pulling systems. One embodiment of the present invention relates to a portable modular hanging and pulling system comprising a first and second bearing member, two coupling members, and a modular surface. The coupling members may be elongated U-shaped rigid support type structures. The first and second bearing members may be coupled at independent lengthwise locations along the coupling members corresponding to the left and bottom regions of the U-shape. The modular surface may be coupled to the coupling members at a lengthwise location corresponding to the right region of the U-shape. The modular surface may include a grid of at least four coupling recesses configured to releasable couple gripping regions including various shaped holds, hangboards, features, accessories, etc. A second embodiment of the present invention relates to a method for attaching a modular surface to a door opening including supporting the modular surface in an exterior region spaced from the door opening. Also, while embodiments are described in reference to a portable modular hanging and pulling system, it will be appreciated that the teachings of the present invention are applicable to other areas including but not limited to other modular systems supported within a door opening.

The following terms are defined as follows:

Door opening—an opening configured to enable a user to walk between two regions. A door opening is generally taller than it is wide.

Axis of entry of a door opening—the axis of travel through a door entry. The axis of entry is generally parallel to the ground or supporting surface.

Hold—a particularly shaped member providing at least one gripping surface and orientation. A user may grip the hold with a one or both hands using to the at least one gripping orientation.

Feature—a larger shaped member providing a plurality of gripping surfaces.

Hangboard—a particularly shaped structure that includes a plurality of gripping surfaces and orientations. A user may grip the hangboard with both hands using the plurality of gripping positions.

Accessories—various anchored training systems including but not limited to rings and suspension trainers.

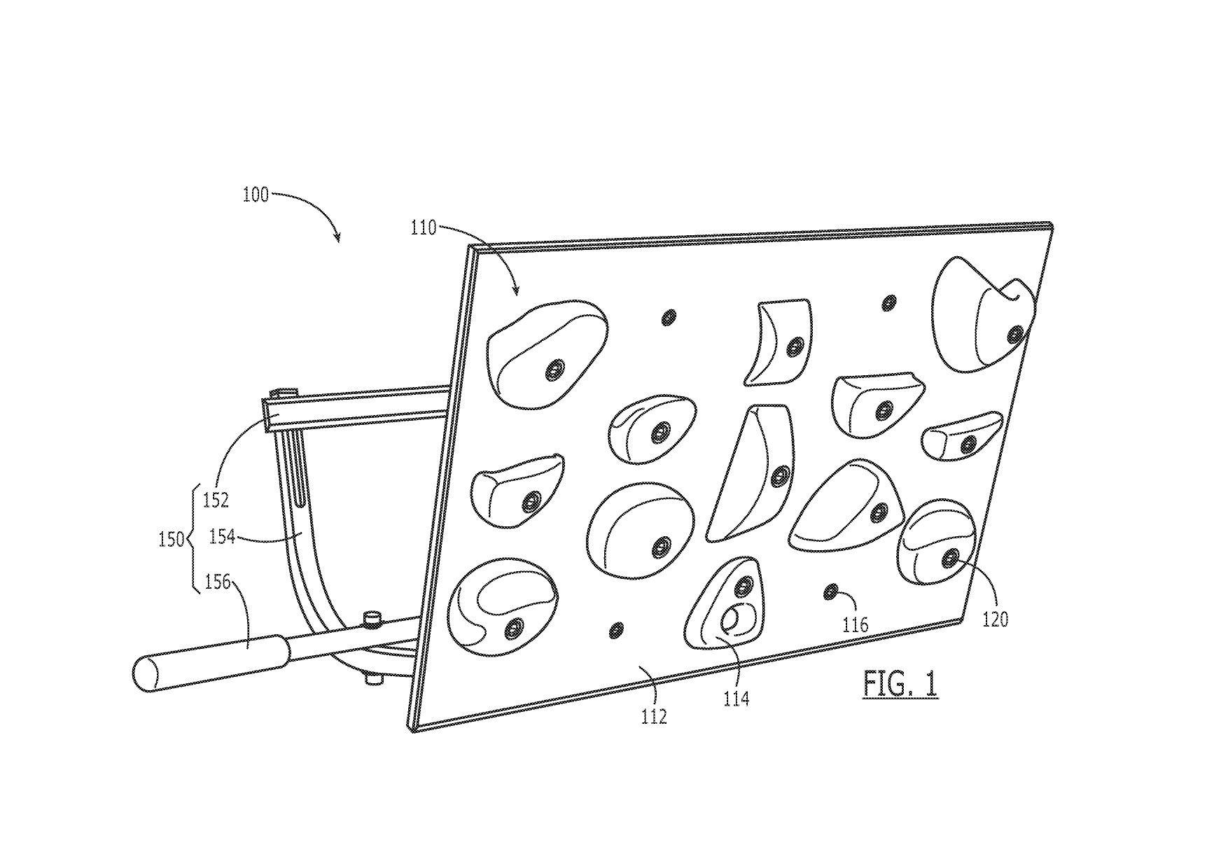

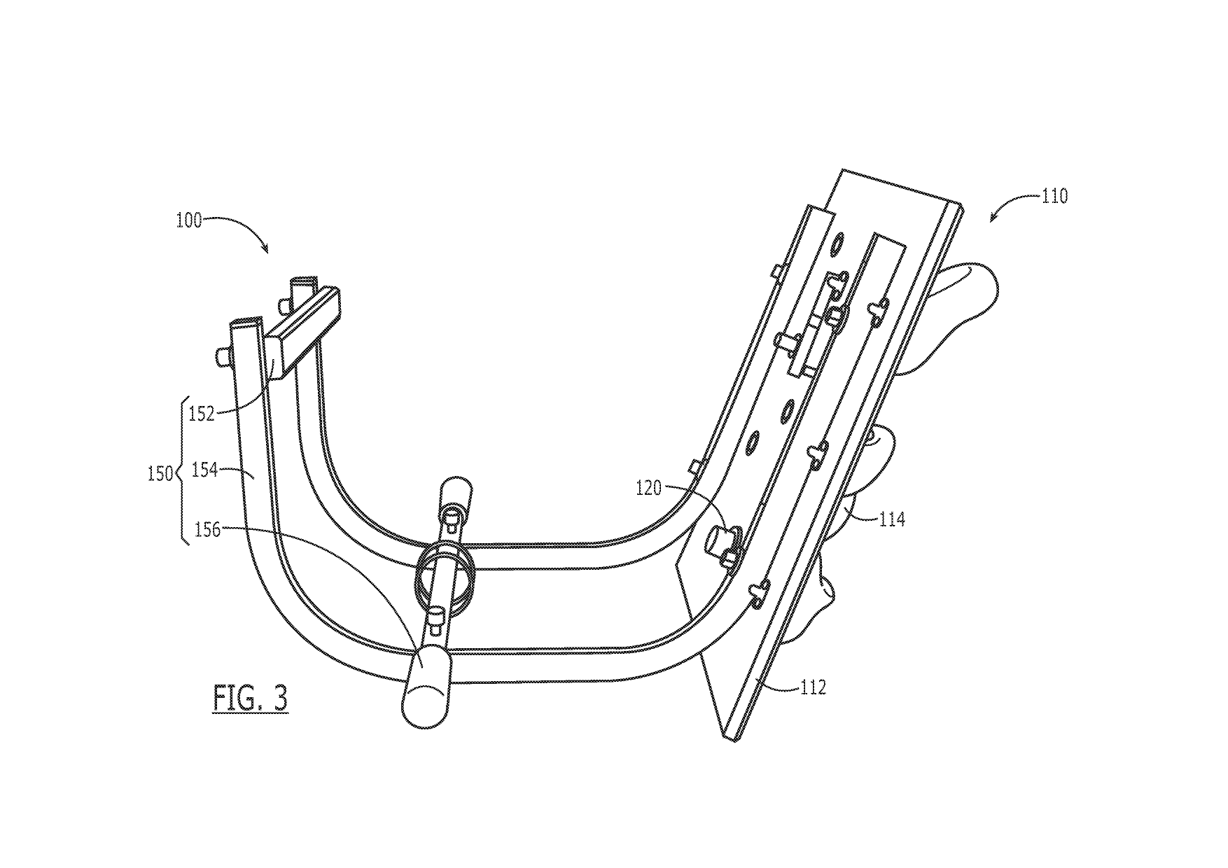

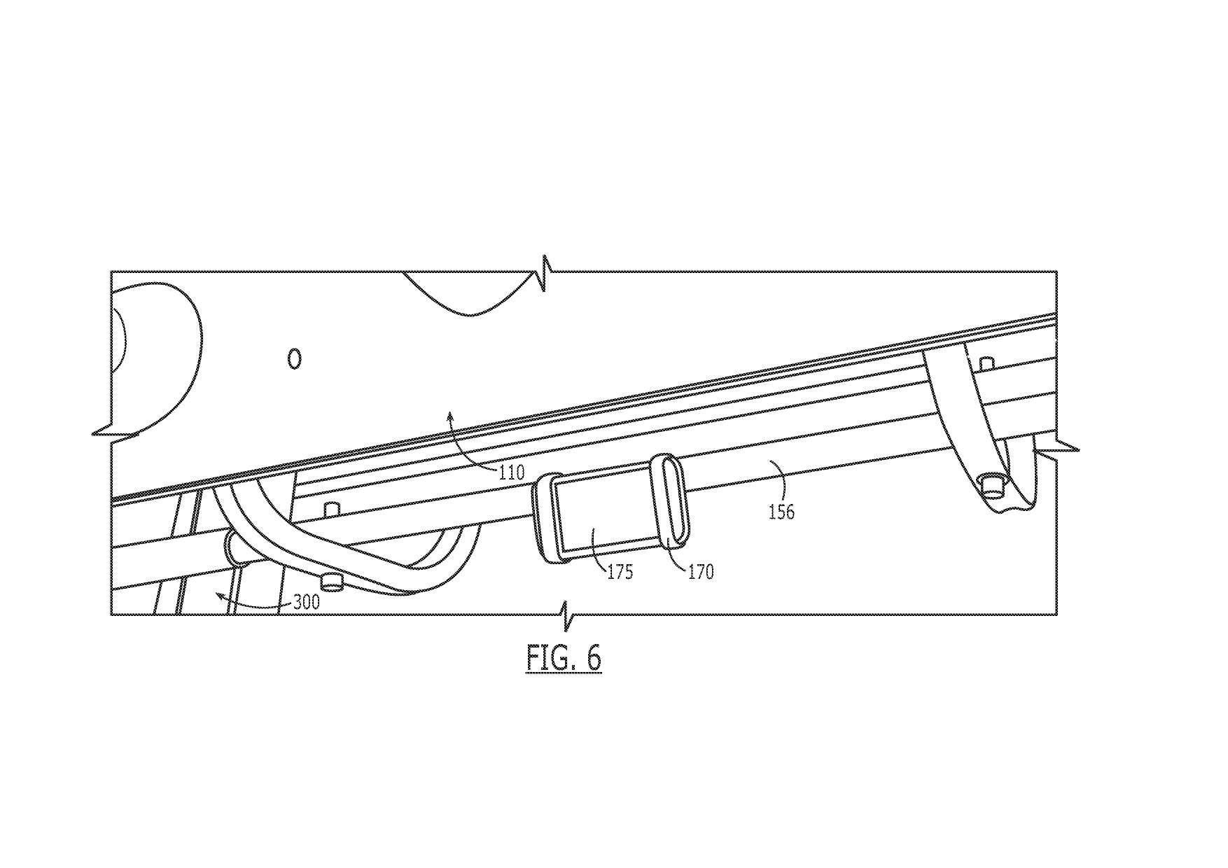

Reference is initially made to FIGS. 1 and 3, which illustrate perspective views of a portable modular hanging and pulling system, designated generally at 100. The system 100 includes a coupling system 150 and a modular surface 110. The coupling system 150 includes a first bearing member 152, a second bearing member 156, and a first and second coupling member 154. The bearing members 152, 156 and the coupling members 154 are rigid supportive structures comprising a material such as metal. The first bearing member 152 may be a flat elongated structure having a particular width configured to be smaller than the width of a standard door opening. The second bearing member 156 may be a round elongated structure having a particular width larger than the width of a standard door opening. Both the first and second bearing members 152, 156 may include one or more padded regions to minimize and/or avoid damaging a door frame during use. The first and second bearing members 152, 156 are coupled to independent lengthwise regions of the coupling members 154 as illustrated. The coupling between the bearing members 152, 156 and the coupling members 154 may include extending a bolt through corresponding recesses and securing with a nut. The coupling location of the second bearing member 156 on the coupling members 154 may be orthogonal to the coupling location of the first bearing member 152. The coupling members 154 may be substantially U-shaped, and therefore the first and second bearing member 152, 156 may be described as being coupled to the left and bottom regions of the U-shape of each of the coupling members 154. The first and second bearing members 152, 156 may also be coupled to the interior side of the coupling members 154. The coupling members 154 may include a plurality of recesses to enable alternative coupling schemes with the bearing members 152, 156. The second bearing surface 156 may also include an entertainment attachment system configured to releasably secure a digital display device on the second bearing surface 156 as illustrated in FIG. 6.

The modular surface 110 includes a base 112, a plurality of modular members 114, a plurality of coupling recesses 116, and a plurality of releasable couplers 120. The base 112 is a rigid substantially two dimensional structure forming a surface upon which modular members 114 may be releasably coupled. The base 112 may be composed of a supportive material including but not limited to wood. The illustrated modular members 114 are holds, features, and/or grips which provide various gripping orientations for a user to perform hanging and pulling type of exercises and movements. The modular members 114 are releasably coupled to the base 112 via a corresponding releasable coupler 120 extending through the modular member 114 and into a corresponding coupling recess 116. It will also be appreciated that the modular surface 110 may provide coupling points for hanging accessories including but not limited to straps, rings, etc. The releasable couplers 120 may be specifically shaped bolts configured to correspond with the coupling recesses 116. The coupling recesses 116 may include a recess extending through the base 112 and a T-nut disposed on part of the rear surface of the base 112. The modular surface 110 may also include a tool 180 to facilitate releasable coupling/decoupling of the modular members 114 to the base 112.

The modular surface 110 and base 112 are coupled to the coupling members 154 at a particular lengthwise location independent of the bearing members 152, 156. The coupling location of the modular surface 110 on the coupling members 154 is greater than ninety degrees from the coupling location of the second bearing members 156. The coupling location of the modular surface 110 includes an elongated region substantially corresponding to the height of the modular surface 110. The coupling between the modular surface 110 and the coupling members 154 may include extending a plurality of bolts through the modular surface 110 and the coupling members 154 and securing with corresponding nuts. In particular, the illustrated embodiment utilizes four couplings between the modular surface 110 and the coupling members 154 so as to securely support the modular surface 110 during operation.

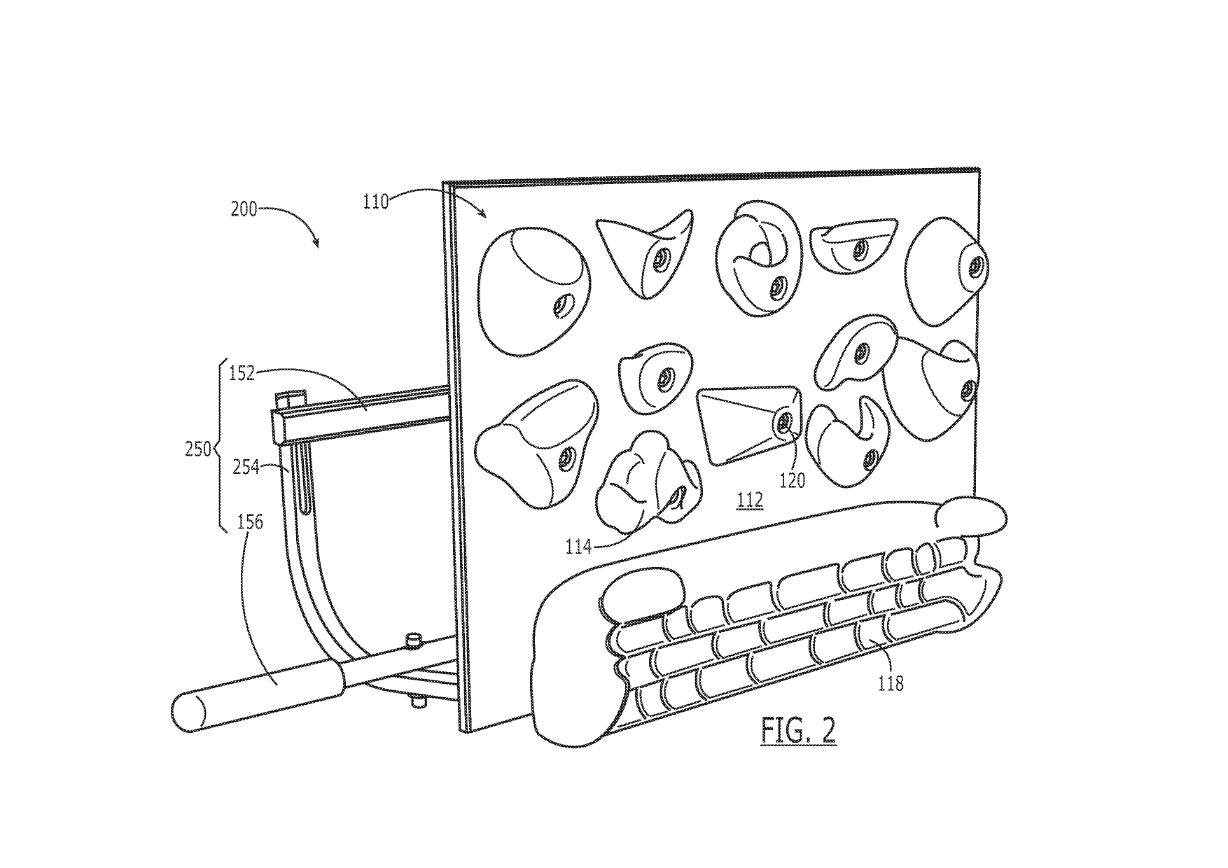

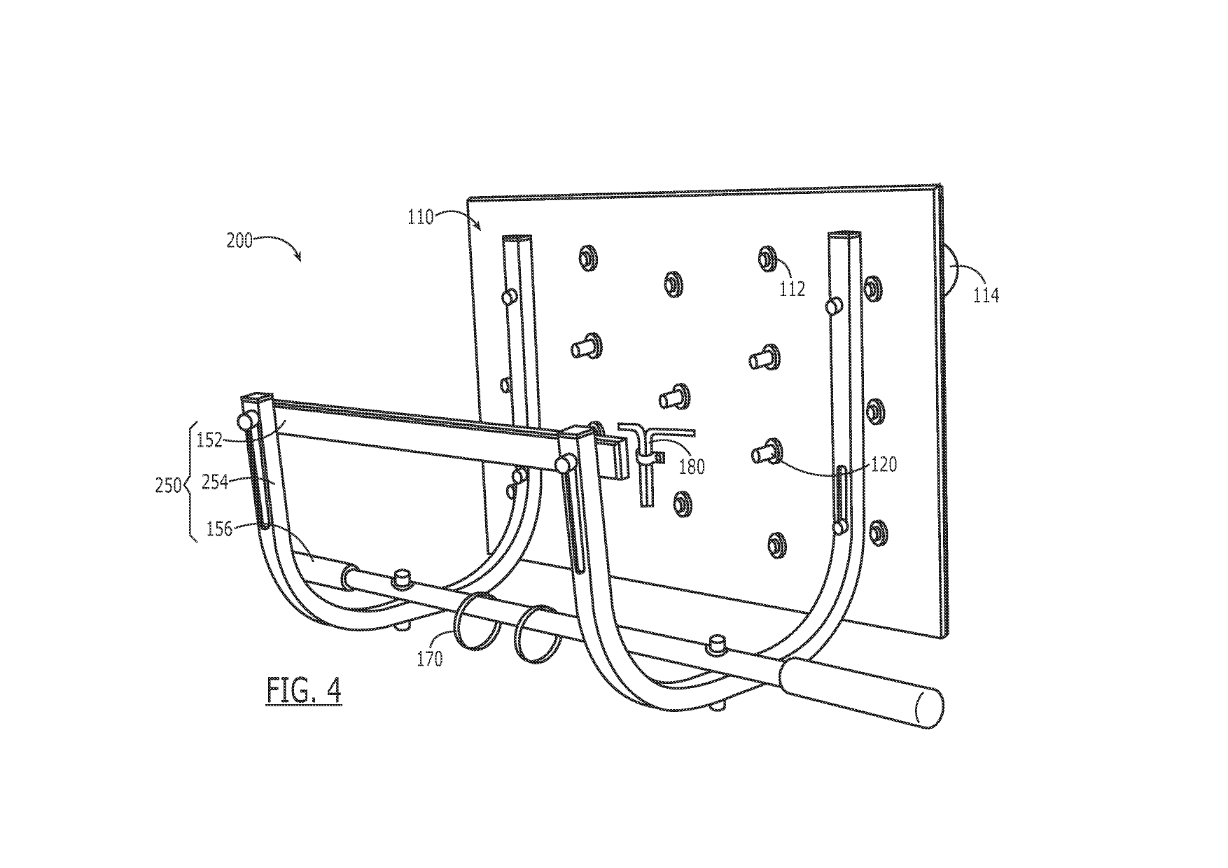

Reference is next made to FIGS. 2 and 4, which illustrates perspective views of an alternative modular hanging and pulling system, designated generally at 200. The alternative system 200 includes a set of alternative coupling members 254 on which the right region is substantially parallel to the left region with respect to U-shape. Therefore, the lengthwise coupling location of the modular surface 110 is substantially parallel to the lengthwise coupling location of the first bearing member 152. In addition, the alternative embodiment illustrates an alternative configuration of coupling members 114 including a hangboard 118. The hangboard 118 is an alternative type of modular member 114 which may also be releasably coupled to the base 112 via the releasable couplers 120 and the coupling recesses 116. Alternatively, the hangboard 118 or any other modular member 114 may be more permanently coupled to the base 112 by extending a wood screw into a blank region of the base (independent of the coupling recesses 116). It will be appreciated that the coupling members 254 may be interchangeable to enable a user to switch between the embodiment illustrated in FIGS. 1/3 and 2/4. The alternative coupling members 254 alter the angle of the modular surface 110 with respect to the ground. Various non-illustrated coupling member geometries may also be utilized in accordance with embodiments of the present invention.

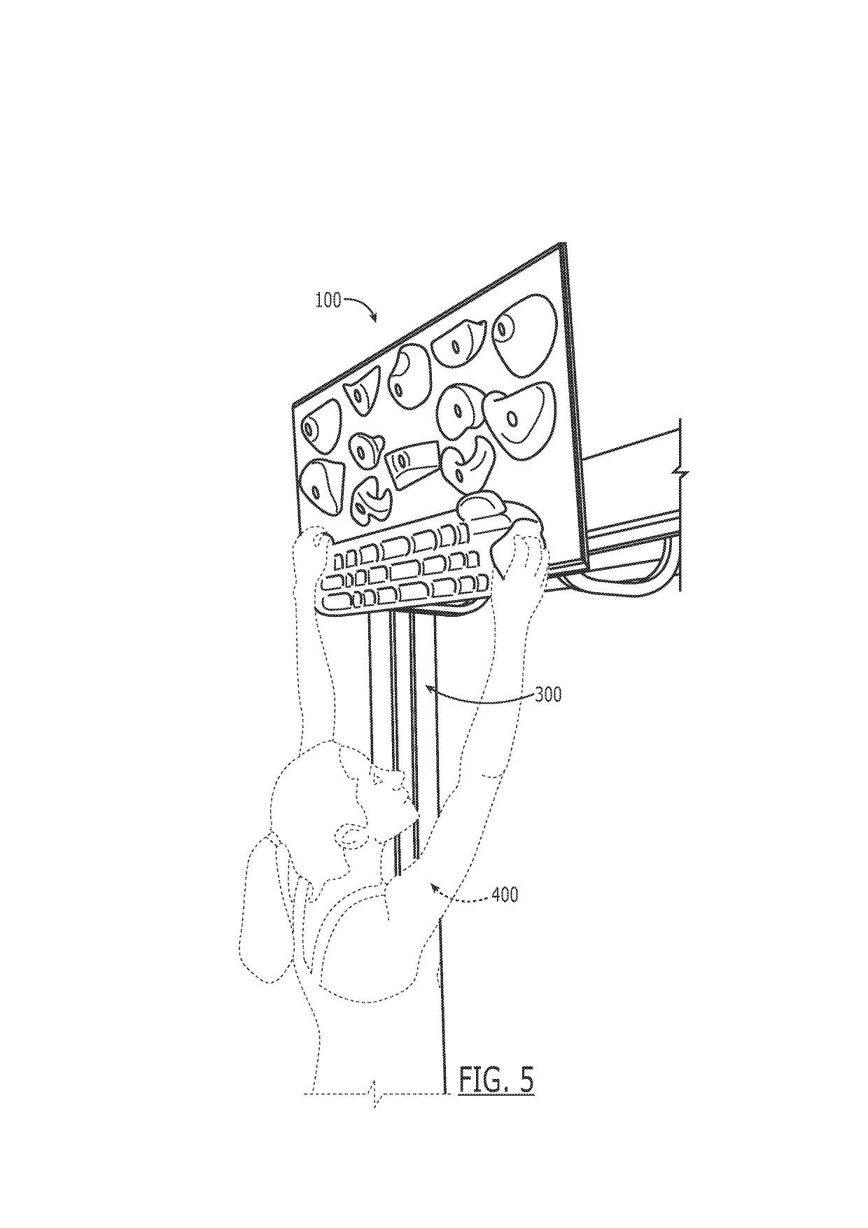

Reference is next made to FIG. 5, which illustrates the operation of the system 200 illustrated in FIG. 2 with respect to a door opening 300 and a user 400. The first bearing member 152 (not visible) is disposed on an interior surface of the door opening 300 above the door opening 300. The second bearing member 156 is disposed across the width of the door opening 300 as illustrated. The user 400 is gripping two independent gripping regions on the modular surface 110 of the system 100. The user 400 can thereby hang and/or pull herself up towards the modular surface 110. During operation, the user generally transfers at least some of her weight onto the gripping surfaces of the modular surface 110. The weight of the user is then transferred from the gripping surface (i.e. modular member 114 or hangboard 118) to the base 112. The base 112 is coupled to the coupling members 154, and thereby transfers the load across the lengthwise dimension of the coupling members 154. The shape and lengthwise orientation of the coupling members 154 causes the force to be exerted simultaneously by both the first bearing member 152 upon the region of the door opening 300 and the second bearing member 156 upon the front of the door opening 300. Since the first and second bearing members 152, 156 are simultaneously exerting forces in opposite directions (against the interior and exterior of the door opening 300), the modular surface 110 and the user 400 are thereby supported. The system may also include an optional independent foot platform on which a user may place one or both feet (not illustrated). The optional foot platform may be disposed within the door opening 300 and enable modular coupling of holds and/or features that simulate rock climbing type foot holds to further increase training effectiveness through accurate simulation.

Reference is next made to FIG. 6, which illustrates a detailed view of the engagement between the system 200 and a door opening 300 to facilitate portability. FIG. 6 further illustrates the positioning of the second bearing member 156 across the width of the door opening 300 with respect to the coupling members 154 and the mounting surface 110. FIG. 6 also illustrates the entertainment coupling system 170 of the second bearing member 156. The entertainment coupling system 170 is illustrated as supporting a portable digital entertainment device 175, which may include a cell phone, tablet, or any portable digital display device.

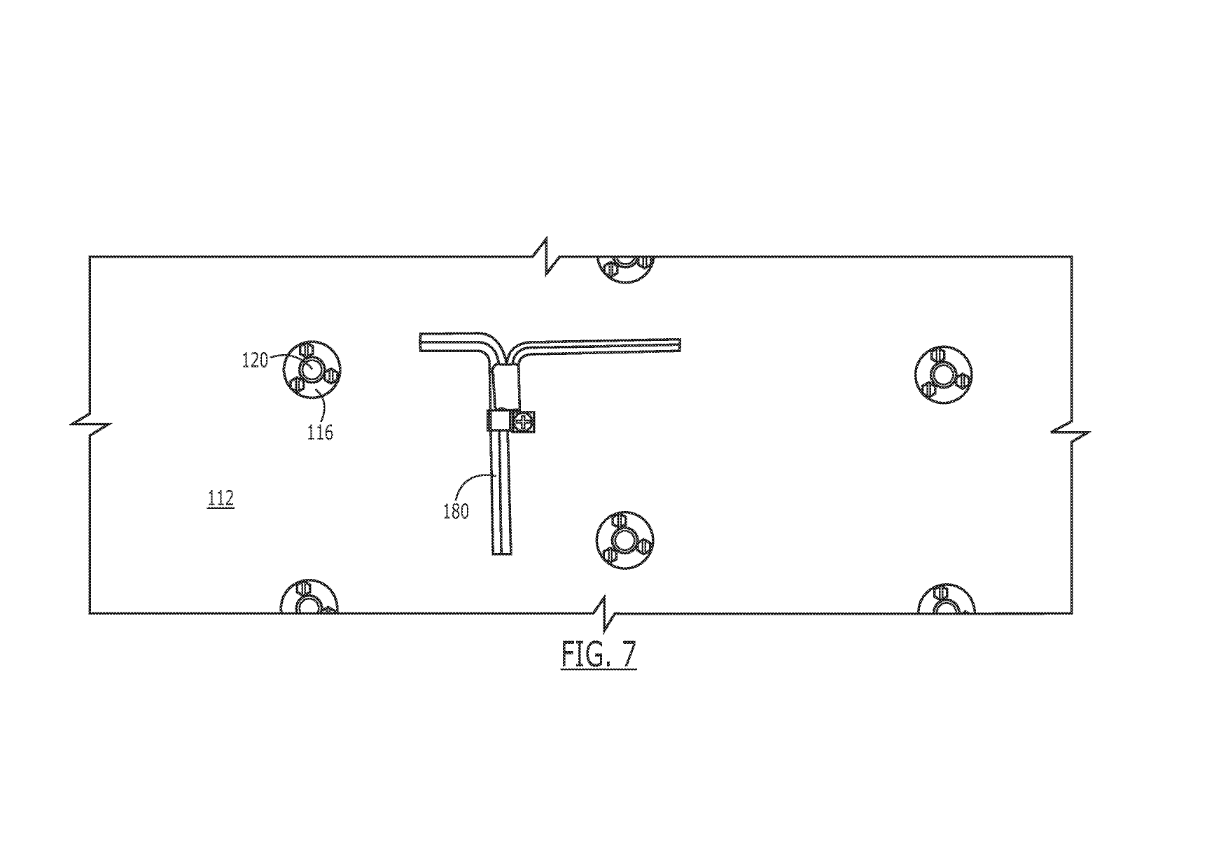

Reference is next made to FIG. 7, which illustrates a detailed rear view of the modular surface 110. The rear surface of the modular surface 110 may include a releasably coupled tool 180 configured to enable the releasable coupling/decoupling of modular members 114 to the base 112.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

What is claimed is:

1. A portable modular hanging and pulling system comprising:
a first and second bearing member;
two coupling members having a plurality of lengthwise locations, wherein the two coupling members are coupled to the first and second bearing members at first and second independent lengthwise locations; and
a modular surface coupled to the two coupling members at a third independent lengthwise location, wherein the second independent lengthwise location is disposed between the first and third independent lengthwise locations, and wherein the modular surface includes a grid of at least four coupling recesses.

2. The system of claim 1, wherein the first and second bearing members are configured to bear upon the rear and front regions of a door opening respectively.

3. The system of claim 2, wherein the second bearing member is wider than the door opening and the first bearing member is narrower than the door opening.

4. The system of claim 1, wherein the first and second coupling members are substantially U-shaped.

5. The system of claim 4, wherein the first, second, and third independent lengthwise locations of the first and second coupling members correspond to the left, bottom, and right portions of the U-shape respectively.

6. The system of claim 1, wherein first and second independent lengthwise locations of the first and second coupling members are disposed on substantially orthogonal regions.

7. The system of claim 1, wherein the third independent lengthwise location of the first and second coupling members is disposed within a region that is angled at least ninety degrees from the region containing the second independent lengthwise location.

8. The system of claim 1, wherein the third independent lengthwise location of the first and second coupling members is disposed within a region that is angled greater than ninety degrees from the region containing the second independent lengthwise location.

9. The system of claim 1, wherein the coupling members include an inner and outer lengthwise side, and wherein the first and second bearing members are coupled to the inner lengthwise side and the modular surface is coupled to the outer lengthwise side.

10. The system of claim 1, wherein the modular surface comprises:
a base having a front and rear surface;
a grid of coupling recesses extending between the front and rear surfaces of the base; and
at least one modular member coupled to the base via at least one releasable coupler extending through both the at least one modular member and at least one of the grid of coupling recesses.

11. The system of claim 10, wherein the grid of coupling recesses are substantially equidistantly spaced in a grid configuration across the front and rear surfaces of the base.

12. The system of claim 10, wherein the at least one modular member includes a plurality of grip regions configured to suspend a user and thereby enable the user to perform hanging and pulling type of exercises.

13. The system of claim 10, wherein the at least one modular member includes at least one of a hold and a hangboard.

14. The system of claim 10, wherein the grip of coupling recesses include T-nuts.

15. A portable modular hanging and pulling system comprising:
a first and second bearing member;
two coupling members having a plurality of lengthwise locations, wherein the two coupling members are coupled to the first and second bearing members at first and second independent lengthwise locations;
a modular surface coupled to the two coupling members at a third independent lengthwise location, wherein the second independent lengthwise location is disposed between the first and third independent lengthwise locations, and wherein the modular surface comprises:
a base having a front and rear surface;
a grid of coupling recesses extending between the front and rear surfaces of the base; and
at least one modular member coupled to the base via at least one releasable coupler extending through both the at least one modular member and at least one of the grid of coupling recesses.

16. A method for coupling a modular surface to a door opening comprising the acts of:
providing a first and second coupling member;
coupling a first bearing member to the first and second coupling member at a first lengthwise location;
coupling a second bearing member to the first and second coupling member at a second lengthwise location orthogonal to the first lengthwise location;
coupling a modular surface to the first and second coupling member at a third lengthwise location such that the second lengthwise location is disposed between the first and third lengthwise location;
orienting the first and second coupling member to extend through the door opening;
positioning the first bearing member against an interior region above the door opening;
positioning the second bearing member across an exterior region of the door opening; and
supporting the modular surface in an exterior region spaced from the door opening.

17. The method of claim 16, wherein the act of supporting the modular surface in an exterior region spaced from the door opening includes supporting the modular surface at an orientation orthogonal to the axis of travel of the door opening.

18. The method of claim 16, wherein the act of supporting the modular surface in an exterior region spaced from the door opening includes supporting the modular surface at an orientation greater than ninety degrees with respect to the axis of travel of the door opening.

19. The method of claim 16, wherein the act of supporting the modular surface in an exterior region spaced from the door opening includes levering the second bearing member against the exterior of the door opening with respect to the first bearing member.

20. The method of claim 16, wherein the act of supporting the modular surface in an exterior region spaced from the door opening includes compressing the first and second bearing member against the door opening.
